(19) United States
(12) Patent Application Publication
(10) Pub. No.: US 2006/0276608 A1
(43) Pub. Date: Dec. 7, 2006

(54) Method for making biomedical devices

(75) Inventors: Weihong Lang, Penfield, NY (US); Yu-Chin Lai, Pittsford, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/145,645

(22) Filed: Jun. 6, 2005

(51) Int. Cl. C08G 77/06; C08G 77/04

(52) U.S. Cl. 528/25; 528/26; 528/28; 524/916

(57) ABSTRACT

A method of making a silicone hydrogel biomedical device involves forming a monomer mixture comprising a silicone-containing monomer and a hydrophilic monomer, and heating the monomer mixture to reduce cloudiness of the mixture.

### FIELD OF THE INVENTION

This invention relates to a method for making silicone hydrogel biomedical devices, especially ophthalmic biomedical devices, where the device is formed by exposing a monomer mixture to light energy in order to cure the monomer mixture.

### BACKGROUND OF THE INVENTION

Biomedical devices are those intended to contact body fluids or body tissue. Such devices include ophthalmic devices such as drug release devices implantable in eye tissue and lenses such as contact lenses and intraocular lenses.

Hydrogels represent a desirable class of materials for the manufacture of various biomedical devices, including ophthalmic devices such as contact lenses. A hydrogel is a hydrated cross-linked polymeric system that contains water in an equilibrium state. Hydrogel lenses offer desirable biocompatibility and comfort. Silicone hydrogels are a known class of hydrogels and are characterized by the inclusion of a silicone-containing material along with a hydrophilic material. Typically, a silicone-containing monomer is copolymerized by free radical polymerization with a hydrophilic monomer, with either the silicone-containing monomer or the hydrophilic monomer functioning as a crosslinking agent (a crosslinker or crosslinking agent being defined as a monomer having multiple polymerizable functionalities) or a separate crosslinker may be employed.

An advantage of silicone hydrogels over non-silicone hydrogels is that silicone hydrogels typically have higher oxygen permeability due to the inclusion of the silicone-containing monomer. Oxygen permeability is a desirable property for many biomedical devices; for example, in the case of contact lenses, the human cornea will be damaged if it is deprived of adequate oxygen for an extended period.

A conventional manner of forming a silicone hydrogel biomedical device involves casting a mixture of monomeric materials in a mold having a desired shape, and curing (or polymerizing) the monomer mixture by free radical polymerization. For example, a free radical polymerization initiator may be included in the monomer mixture, and the monomer mixture is cured by exposure to light energy (photopolymerization).

A problem encountered in curing monomer mixtures for silicone hydrogels is that the silicone-containing monomer may be incompatible with the hydrophilic monomer. More specifically, silicone-containing monomers are hydrophobic, especially silicone-containing monomeric materials having a higher silicon content. When such hydrophobic monomers are mixed with the hydrophilic monomer, the resultant monomer mixture may be non-uniform, for example, it may exhibit phase separation and/or appear cloudy. When a non-uniform monomer mixture is cured, the resultant device has a non-uniform consistency and may be cloudy, which is undesirable for biomedical devices, especially ophthalmic devices intended to be optically clear.

One manner of improving compatibility of silicone-containing monomers and hydrophilic monomers involves employing a diluent in the monomer mixture, a diluent is defined as a material that lessens incompatibility of these monomeric materials and is substantially nonreactive with these monomeric materials. The inclusion of a diluent in monomer mixtures for silicone hydrogels is disclosed in various literature including U.S. Pat. No. 5,260,000 (Nandu et al.). However, the present invention recognized that the inclusion of a diluent may not entirely resolve the issue of incompatibility of some monomer mixtures, especially monomer mixtures employing silicone-containing monomers with a higher silicon atom content. Further, the present invention recognized that some monomer mixtures require a large amount of diluent which can lead to difficulties in processing of the device following polymerization.

### SUMMARY OF THE INVENTION

This invention provides a method of making a silicone hydrogel biomedical device, comprising: forming a monomer mixture comprising a silicone-containing monomer and a hydrophilic monomer; heating the monomer mixture to reduce cloudiness of the mixture; and curing the monomer mixture. Preferably, the monomer mixture is heated until it is optically clear. The monomer mixture may be cured by exposing the monomer mixture to light energy, such as ultraviolet light. The mixture may be retained in a mold during curing, such as a lens-shaped mold.

The silicone-containing monomer may include a polysiloxane-containing prepolymer, such as a polysiloxane prepolymer has a silicon atom content of at least 25 weight % of the prepolymer. The hydrophilic monomer may include unsaturated carboxylic acids, (meth)acrylic substituted alcohols, vinyl lactams; and (meth)acrylamides, such as methacrylic acid, acrylic acid, 2-hydroxyethylmethacrylate, N-vinyl pyrrolidone, methacrylamide, and N,N-dimethylacrylamide.

Preferred biomedical devices are ophthalmic devices, including ophthalmic lenses such as contact lenses and intraocular lenses.

### DETAILED DESCRIPTION OF VARIOUS PREFERRED EMBODIMENTS

The silicone hydrogels employed in this invention are the hydrated polymerization product of a monomeric mixture comprising a silicone-containing monomer and a hydrophilic monomer. A hydrogel is a crosslinked polymeric system that can absorb and retain water in an equilibrium state. The monomeric mixtures employed in the invention include conventional device-forming monomers, or conventional lens-forming monomers in the case of ophthalmic lenses. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.)

A first class of silicone-containing monomers are polysiloxane-containing prepolymers endcapped with polymerizable ethylenically unsaturated radicals.

The term “polysiloxane-containing” denotes that the prepolymer includes polysiloxane-containing soft segments. These segments are preferably derived from polysiloxanes endcapped with hydroxyl or amino radicals and represented by the following formula (PS′):

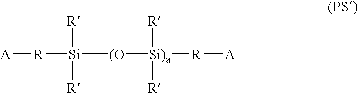

wherein each A is a hydroxyl or amino radical;

each R is independently selected from an alkylene group having 1 to 10 carbon atoms wherein the carbon atoms may include ether, urethane or urea linkages therebetween;

each R′ is independently selected from hydrogen, monovalent hydrocarbon radicals or halogen substituted monovalent hydrocarbon radicals wherein the hydrocarbon radicals have 1 to 20 carbon atoms which may include ether linkages therebetween, and

a is at least 1.

Preferred R radicals are alkylene optionally substituted with ether radicals. Preferred R′ radicals include: alkyl groups, phenyl groups, fluoro-substituted alkyl groups and alkenyl groups, optionally substituted ether groups. Especially preferred R′ radicals include: alkyl, such as methyl; or fluoroalkyl optionally including ether linkages, such as —CH2-CH2-CH2—O—CH2-(CF2)z-H where z is 1 to 6.

Preferably, a is about 10 to about 100, more preferably about 15 to about 80. The Mn of PS′ ranges from 1000 to 8000, more preferably 2000 to 6000.

Various polysiloxane-diols and polysiloxane-diamines are commercially available. Additionally, representative syntheses of polysiloxanes are provided in the Examples.

The term “prepolymer endcapped with polymerizable ethylenically unsaturated radicals” denotes that the prepolymer is polymerizable and is endcapped with the ethylenically unsaturated radicals. The prepolymers are endcapped at both ends with a polymerizable ethylenic unsaturated radical. Preferred terminal polymerizable radicals are represented by formula (M′):

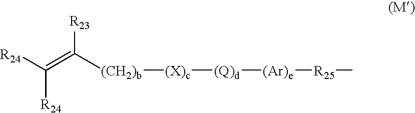

wherein:

R₂₃ is hydrogen or methyl;

each R₂₄ is hydrogen, an alkyl radical having 1 to 6 carbon atoms, or a —CO—Y—R₂₆ radical wherein Y is —O—, —S— or —NH—;

R₂₅ is a divalent alkylene radical having 1 to 10 carbon atoms;

R₂₆ is a alkyl radical having 1 to 12 carbon atoms;

Q denotes —CO—, —OCO— or —COO—;

X denotes —O— or —NH—;

Ar denotes an aromatic radical having 6 to 30 carbon atoms; b is 0 to 6; c is 0 or 1; d is 0 or 1; and e is 0 or 1. Suitable endcapping precursors, for forming the M radicals, include: hydroxy-terminated (meth)acrylates, such as 2-hydroxyethylmethacrylate, 2-hydroxyethylacrylate, and 3-hydroxypropylmethacrylate; and amino-terminated (meth)acrylates, such as t-butylaminoethylmethacrylate and aminoethylmethacrylate; and (meth)acrylic acid. (As used herein, the term “(meth)” denotes an optional methyl substituent. Thus, terms such as “(meth)acrylate” denotes either methacrylate or acrylate, and “(meth)acrylic acid” denotes either methacrylic acid or acrylic acid.)

One class of polysiloxane prepolymers comprises blocks (I) and (II) and is terminated at each end with an ethylenic unsaturated radical:
(*Dii*Diol*Dii*PS)ₓ (I)
(*Dii*PS)_{y} (II)
wherein:

each Dii is independently a diradical residue of a diisocyanate;

each Diol is independently a diradical residue of a diol having 1 to 10 carbon atoms;

each PS is independently a diradical residue of a polysiloxane-diol or -diamine (i.e., the diradical residue of PS′, where A would be —O— or —NH—);

each * is independently —NH—CO—NH—, —NH—COO— or —OCO—NH—:

x represents the number of blocks (I) and is at least 2, and

y represents the number of blocks (II) and is at least 1.

This class of prepolymers includes those represented by the general formulae:
M(*Dii*Diol*Dii*PS)ₓ(*Dii*PS)_{y}*Dii*M (III) or
M(*Dii*Diol*Dii*PS)ₓ(*Dii*PS)_{y}*Dii*Diol*Dii*M (IV)
wherein Dii, Diol, PS, PS′, *, x and y are as defined above, and M is a polymerizable ethylenically unsaturated radical.

Generally, the blocks of formula (I) may be characterized as composed of strong hard segments (represented by *Dii*Diol*Dii*) and soft segments (represented by PS). Generally, the blocks of formula (II) may be characterized as composed of weaker hard segments (represented by *Dii*) and soft segments (represented by PS). The distribution of these weaker and strong hard blocks (I) and (II) may be random or alternate, where x and y represent the total number of blocks of respective structures in the prepolymer; stated differently, it is not necessary in formulae (III) and (IV) that all blocks of formula (I) are directly linked to each other. The distribution of these blocks may be controlled by the sequence of addition of the polysiloxane, diisocyanate and short chain diol ingredients during the preparation of the prepolymer.

The prepolymers include polysiloxane-containing soft segments, represented by PS in formulae (I), (II), (III) and (IV). More particularly, this polysiloxane-containing segment is derived from polysiloxanes endcapped with hydroxyl or amino radicals, such as polysiloxane segments represented by formula (PS′).

Preferably, a in formula (III) and (IV) is about 10 to about 100, more preferably about 15 to about 80. The Mn of PS ranges from 1000 to 8000, more preferably 2000 to 6000.

The strong hard segments of the prepolymers include the residue of a diol, represented by Diol in formulae (I), (III) and (IV). Preferred Diol radicals include the diradical residue of an alkyl diol, a cycloalkyl diol, an alkyl cycloalkyl diol, an aryl diol or an alkylaryl diol having 1 to 10 carbon atoms and which may contain ether, thio or amine linkages in the main chain. Representative diols include 2,2-(4,4′-dihydroxydiphenyl)propane (bisphenol-A), 4,4′-iso-propylidine dicyclohexanol, ethoxylated and propoxylated bisphenol-A, 2,2-(4,4′-dihydroxydiphenyl)pentane, 1,1′-(4,4′-dihydroxydiphenyl)-p-diisopropyl benzene, 1,3-cyclohexane diol, 1,4-cyclohexane diol, 1-4-cyclohexane dimethanol, neopentyl glycol, 1,4-butanediol, 1,3-propanediol, 1,5-pentanediol, ethylene glycol, diethylene glycol and triethylene glycol. Especially preferred are alkylene and etherified alkylene diols having 1 to 10 carbon atoms.

The aforementioned polysiloxane-containing segments and diol residue segments are linked via diisocyanates that react with hydroxyl- or amino-functionality of the polysiloxane-containing segments and diols. Generally, any diisocyanate may be employed. These diisocyanates may be aliphatic or aromatic, and include alkyl, alkyl cycloalkyl, cycloalkyl, alkyl aromatic and aromatic diisocyanates preferably having 6 to 30 carbon atoms in the aliphatic or aromatic moiety. Specific examples include isophorone diisocyanate, hexamethylene-1,6-diisocyanate, 4,4′-dicyclohexylmethane diisocyanate, toluene diisocyanate, 4,4′-diphenyl diisocyanate, 4,4′-diphenylmethane diisocyanate, p-phenylene diisocyanate, 1,4-phenylene 4,4′-diphenyl diisocyanate, 1,3-bis-(4,4′-isocyanto methyl)cyclohexane, and cyclohexane diisocyanate.

Generally, higher x values results in prepolymers have a higher number of polar urethane/urea linkages, and polarity of the prepolymer is important to ensure compatibility with hydrophilic co-monomers. Generally, higher y values results in prepolymers with a higher percentage of silicon, resulting in higher oxygen permeability. However, the ratio of x and y should be balanced. Accordingly, the ratio of x to y is preferably at least 0.6 (i.e., x:y is at least 0.6:1), more preferably at least 0.75.

The prepolymers are endcapped at both ends with a polymerizable ethylenic unsaturated radical, represented by M in formulae (III) and (IV). Representative M radicals are represented by formula (M′).

A first representative reaction scheme for forming the prepolymers is as follows. First, a diisocyanate is reacted with a diol, at a molar ratio of 2:1, respectively.
2xOCN-Dii-NCO+xHO-Diol-OH→x OCN-Dii*Diol*Dii-NCO

In this scheme, * designates a urethane radical —NH—COO— or —OCO—NH—: Generally, this reaction is conducted in the presence of a catalyst, such as dibutyl tin dilaurate and in a solvent, such as methylene chloride, and under reflux. Then, a diisocyanate and the polysiloxane-diol are added, with the ratio of total diisocyanates (x+y) to polysiloxane-diol being at least 1.1. (Generally, 2<x+y≦11; x>0; y>0.)
xOCN-Dii-*-Diol-*-Dii-NCO+(x+y−1)HO—PS—OH+yOCN-Dii-NCO→OCN-(Dii*Diol*Dii*PS)ₓ(*Dii*PS)_{y}*Dii-NCO

Finally, this product is endcapped with the polymerizable ethylenically unsaturated radical.
OCN-(Dii*Diol*Dii*PS)ₓ(*Dii*PS)_{y}*Dii-NCO+2M-OH→M(*Dii*Diol*Dii*PS)ₓ(*Dii*PS)_{y}*Dii*M

A second representative reaction scheme for forming the prepolymers of formula (I), (II), (III) and/or (IV) is as follows. First, a diisocyanate is reacted with the polysiloxane-diol at a molar ratio shown below, where (1+1/m) preferably ranges from 1.05 to 1.9, most preferably from 1.2 to 1.5.
(m+1)OCN-Dii-NCO+mHO—PS—OH→OCN-(Dii*PS)ₘ*Dii-NCO

In this scheme, * again designates a urethane radical —NH—COO— or —OCO—NH—. Generally, this reaction is conducted in the presence of a catalyst, such as dibutyl tin dilaurate and in a solvent, such as methylene chloride, and under reflux. Then, the diol is added, with the molar ratio selected based on the desired ratio of strong and weak hard segments, with reflux continued, where z1/z2 is equal to or lower than 2 but higher than 1.
z1OCN-(Dii-*-PS)ₘ-*-Dii-NCO+z2HO-Diol-OH→OCN-Dii*Diol*Dii*PS)ₓ(*Dii*PS)_{y}*Dii-NCO

Finally, this product is endcapped with the polymerizable ethylenically unsaturated radical.
OCN-Dii*Diol*Dii*PS)ₓ(*Dii*PS)_{y}*Dii-NCO+2 M-OH→M(*Dii*Diol*Dii*PS)ₓ(*Dii*PS)_{y}*Dii*M

In the above reaction schemes, the reaction of diols with diisocyanates yields urethane radicals (—NH—COO— or —OCO—NH—). Alternatively, the reaction of diamines with diisocyantes would yield urea radicals (—NH—CO—NH—). Other methods for forming urethane or urea polymers are known in the art.

A second class of polysiloxane prepolymers are represented by the formula:
M(*Dii*PS)ₓ*Dii*M (V)

wherein:
Dii, PS, * and M have the same meanings as above. Generally, the *Dii*PS blocks of formula (I) may be characterized as composed of relatively weak hard segments (represented by *Dii*) and soft segments (represented by PS). In formula (V), x is at least two, more preferably at least three.

A representative reaction scheme for forming this class of prepolymers is as follows. First, a diisocyanate is reacted with the polysiloxane-diol.
(n+1)OCN-Dii-NCO+nHO—PS—OH→OCN-(Dii*PS)x*Dii-NCO

In this scheme, * designates a urethane radical —NH—COO— or —OCO—NH—. Generally, this reaction is conducted in the presence of a catalyst, such as dibutyl tin dilaurate and in a solvent, such as methylene chloride, and under reflux.

Finally, this product is endcapped with the polymerizable ethylenically unsaturated radical.
OCN-(Dii*PS)ₓ*Dii-NCO+2M-OH→M(*Dii*PS)ₓ*Dii*M

In the above reaction scheme, the reaction of the polysiloxane-diol with the diisocyanate yields urethane radicals (—NH—COO— or —OCO—NH—). Alternatively, the reaction of poly-siloxane-diamines with diisocyanates would yield urea radicals (NH—CO—NH—). Other methods for forming urethane or urea polymers are known in the art.

Additional polysiloxane-containing prepolymers are represented by the formulae:
M(*Dii*PS*Dii*Diol)ₓ*Dii*PS*Dii*M (VI)
M(*Dii*Diol*Dii*PS)ₓ*Dii*Diol*Dii*M (VII)
where Dii, PS, Diol, * and Dii have the same meanings as above. In formulae (VI) and (VII), x is at least one. Generally, these prepolymers are composed of alternating strong hard segments (represented by *Dii*Diol*Dii*) and soft segments (represented by PS). These prepolymers may be prepared by methods generally known in the art, including the general methods disclosed in U.S. Pat. No. 5,034,461 (Lai et al.), the entire disclosure of which is incorporated herein by reference.

A further class of polysiloxane prepolymers are represented by the formula:
M(*PS*Dii)_{x′}*PS*M (VIII)

wherein:

Dii, PS, * and M have the same meanings as above, and x′ is zero or an integer of at least one. Generally, the *PS*Dii blocks of formula (I) may be characterized as composed of relatively weak hard segments (represented by *Dii*) and soft segments (represented by PS).

A representative reaction scheme for forming this class of prepolymers is as follows. First, a diisocyanate is reacted with the polysiloxane-diol.
(n)OCN-Dii-NCO+(n+1)HO—PS—OH→H—(PS*Dii)x′*PS—H

In this scheme, * designates a urethane radical —NH—COO— or —OCO—NH—. Generally, this reaction is conducted in the presence of a catalyst, such as dibutyl tin dilaurate and in a solvent, such as methylene chloride, and under reflux. Finally, this product is endcapped with the polymerizable ethylenically unsaturated radical.
H—(PS*Dii)x′*PS—H+2M-NCO→M(*PS*Dii)_{x′}*PS*M

In the above reaction scheme, the reaction of the polysiloxane-diol with the diisocyanate yields urethane radicals (—NH—COO— or —OCO—NH—). Alternatively, the reaction of poly-siloxane-diamines with diisocyanates would yield urea radicals (NH—CO—NH—). Other methods for forming urethane or urea polymers are known in the art.

Preferably, the prepolymer has a molecular weight (Mn) of at least 10,000, more preferably at least 15,000, and most preferably at least 20,000. Preferably, the prepolymer has a silicon atom content of at least 25 weight % of the prepolymer, more preferably at least 30 weight %.

Additional examples of polysiloxane prepolymers include the following: 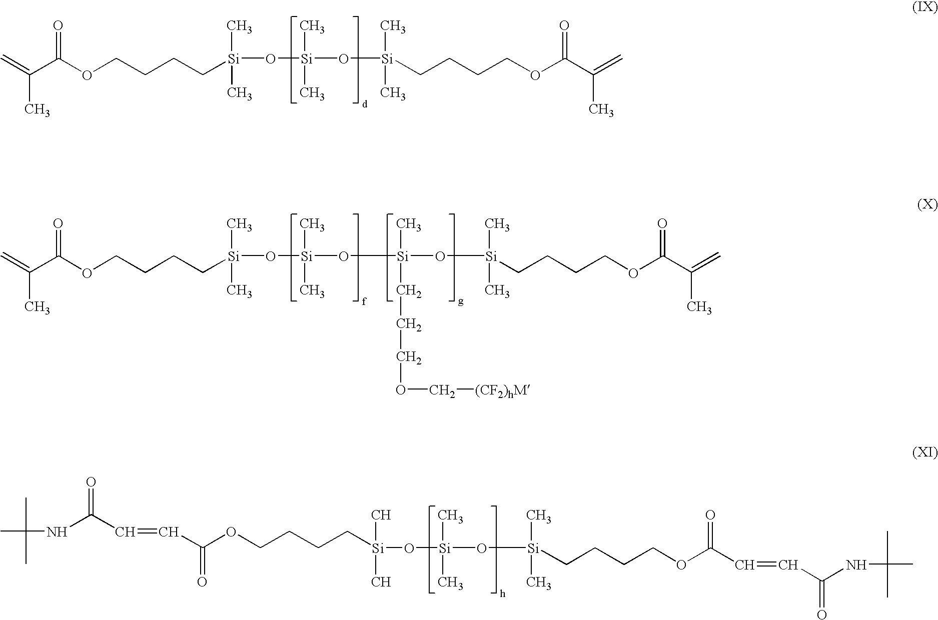
wherein:

d, f, g and k range from 0 to 250, preferably from 2 to 100; h is an integer from 1 to 20, preferably 1 to 6; and

M′ is hydrogen or fluorine.

Another suitable class of silicone-containing monomers include known bulky, monofunctional polysiloxanylalkyl monomers represented by Formula (IX):

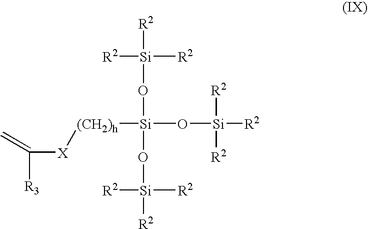

X denotes —COO—, —CONR⁴—, —OCOO—, or —OCONR⁴— where each where R⁴ is H or lower alkyl; R³ denotes hydrogen or methyl; h is 1 to 10; and each R² independently denotes a lower alkyl or halogenated alkyl radical, a phenyl radical or a radical of the formula
—Si(R⁵)₃
wherein each R⁵ is independently a lower alkyl radical or a phenyl radical. Such bulky monomers specifically include methacryloxypropyl tris(trimethylsiloxy)silane (TRIS), pentamethyldisiloxanyl methylmethacrylate, tris(trimethylsiloxy)methacryloxy propylsilane, methyldi(trimethylsiloxy)methacryloxymethyl silane, 3-[tris(trimethylsiloxy)silyl]propyl vinyl carbamate, and 3-[tris(trimethylsiloxy)silyl]propyl vinyl carbonate.

Various other difunctional and multifunctional silicone-containing monomers are known in the art and may be used as a comonomer if desired.

Generally, the initial monomer mixture includes silicone-containing monomers at 5 to 95 weight percent, preferably 20 to 70 weight percent, of the total weight of the mixture.

At least one hydrophilic comonomer is combined with the silicone-containing monomer in the initial monomeric mixture. Representative hydrophilic monomers include: unsaturated carboxylic acids, such as methacrylic and acrylic acids; (meth)acrylic substituted alcohols, such as 2-hydroxyethylmethacrylate, 2-hydroxyethylacrylate and glyceryl methacrylate; vinyl lactams, such as N-vinyl pyrrolidone; and (meth)acrylamides, such as methacrylamide and N,N-dimethylacrylamide. Generally, at least one hydrophilic monomer is included in the monomer mixture at 20 to 60 weight percent, preferably 25 to 50 weight percent, of the total weight of the mixture.

The monomer mixture includes a crosslinking monomer (a crosslinking monomer or crosslinker being defined as a monomer having multiple polymerizable functionalities). In the case where the silicone-containing monomer is a prepolymer endcapped at both ends with a polymerizable radical, these prepolymers will function as a crosslinker. Optionally, a supplemental crosslinking monomer may be added to the initial monomeric mixture. Representative crosslinking monomers include: divinylbenzene, allyl methacrylate, ethyleneglycol dimethacrylate, tetraethyleneglycol dimethacrylate, polyethyleneglycol dimethacrylate, vinyl carbonate derivatives of the glycol dimethacrylates, and methacryloxyethyl vinylcarbonate. When a supplemental crosslinking agent is employed, this monomeric material may be included in the monomer mixture at 0.1 to 20 weight percent, more preferably at 0.2 to 10 weight percent.

In the case of intraocular lenses, the monomer mixtures may further include a monomer for increasing the refractive index of the resultant copolymer. Examples of such monomers are aromatic (meth) acrylates, such as phenyl (meth)acrylate, phenylethyl (meth)acrylate and benzyl (meth)acrylate.

An organic diluent may be included in the initial monomeric mixture. As used herein, the term “organic diluent” encompasses organic compounds that are substantially unreactive with the components in the initial mixture, and are often used to minimize incompatibility of the monomeric components in this mixture. Representative organic diluents include: monohydric alcohols, such as C2-C10 monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene. It is preferred, however, that the diluent is employed in amounts no higher than 20 weight percent, based on total weight of the monomer mixture.

The monomer mixture may further include minor amounts of a polymerization imitator, especially a UV or visible light initiator, a tint, and a UV blocking agent, each of which are known in the art.

The silicone hydrogels preferably have a water content of at least 20 weight percent, a tensile modulus no greater than 100 g/mm2, and/or an oxygen permeability of at least 60 barrers, when measured by the methodology described below. Especially preferred hydrogels have a tensile modulus between about 40 and 80 g/mm2, and/or an oxygen permeability of at least 100 barrers. Additionally, this invention is particularly useful for silicone hydrogels having a water content of at least 30 weight percent, noting that with higher water content and an accompanying higher amount of hydrophilic monomer, phase separation of the hydrophilic monomer and silicone-containing monomer is more likely to occur, resulting in haziness or cloudiness.

In forming lenses or other biomedical devices, the monomeric mixtures may be charged to a mold having a molding surface with a desired shape, and then subjected to light radiation, such as UV radiation or visible light, to effect curing, or free radical polymerization, of the monomer mixture in the mold. Various processes are known for curing a monomeric mixture in the production of contact lenses or other biomedical devices, including spincasting and static casting. Spincasting of contact lenses involves charging the monomer mixture to a mold having a concave, lens-shaped molding surface, and spinning the mold in a controlled manner while exposing the monomer mixture to light. Static casting methods involve charging the monomer mixture between two mold sections forming a mold cavity providing a desired article shape, and curing the monomer mixture by exposure to heat and/or light. In the case of contact lenses, one mold section has a mold surface shaped to form the anterior lens surface and the other mold section has a mold surface shaped to form the posterior lens surface. If desired, curing of the monomeric mixture in the mold may be followed by a machining operation in order to provide a contact lens or article having a desired final configuration. Such methods are described in U.S. Pat. Nos. 3,408,429, 3,660,545, 4,113,224, 4,197,266, 5,271,875, and 5,260,000, the disclosures of which are incorporated herein by reference. Additionally, the monomer mixtures may be cast in the shape of rods or buttons, which are then lathe cut into a desired shape, for example, into a lens-shaped article.

According to the method of this invention, the monomer mixtures are formed by mixing the monomeric components. The monomer mixture is then heated to reduce, and preferably to remove, any cloudiness or haze of the monomer mixture. Preferably, the monomer mixture is heated so that this mixture becomes optically clear. As used herein, “optically clear” denotes that no cloudiness or haziness or turbidity is evident to the human eye. As used herein, the term “heated” denotes that the temperature of the monomer mixture is raised. Preferably, the monomer mixture is heated to within the range of 35 to 100° C., preferably to 40 to 70° C.

If the monomer mixture further includes initiator, tint or diluent, these components can be added to the monomer mixture either before or after heating.

The monomer mixture may be heated by any suitable method. As a first example, the monomer mixture may be heated by directing heating air, or other heated gas (such as nitrogen) to the monomer mixture or the receptacle in which it is held. Examples include a hot air gun or a blower of heated gas. As a second example, the monomer mixture may be placed in an oven chamber for a predetermined time. If desired, the oven may be the same chamber in which subsequent curing of the monomer mixture is effected by exposure to light energy. As a third example, the monomer mixture and its receptacle may be contacted with a heated plate. As another example, the monomer mixture and its receptacle may be placed in a thermal bath of water or other liquid. As yet another example, the monomer mixture may be exposed to a radiant heat source such as an infrared lamp. Other manners of heating are suitable, and combinations of the aforementioned methods may be employed.

It is noted that after heating the monomer mixture, curing of the monomer mixture should be effected without letting the monomer mixture cool down excessively. If the monomer mixture is allowed to cool to too low a temperature, separation of the monomeric components may reoccur.

After curing, the lens is recovered, for example, by releasing the lens from the mold in which it was cast. The lens may be subjected to various other known processes including at least one of: extraction of contaminants from the lens with a solvent (such as isopropanol, including anhydrous isopropanol if desired); surface treatment of a lens surface; inspection; hydration with water or an aqueous solution (such as buffered saline solution); and packaging. All such processes are well-known in the art.

### EXAMPLE 1

### Preparation of α,ω-bis(4-hydroxybutyl)polydimethylsiloxane (Mn about 5000)

The following were charged to a 2-L, three-neck round-bottom flask equipped with one reflux condenser: 51.26 grams of 1,3-bishydroxybutyl tetramethyldisiloxane; 1085 grams of dimethoxydimethylsilane; 157.8 grams of distilled water; and 18.4 mL of concentrated hydrochloric acid. The mixture was heated at 60° C. for 1 hour. Methanol was then distilled off over a 5-hour period, with 552 mL collected. Then, 349 ml distilled water and 349 mL concentrated HCl were added, and the contents were refluxed at 100° C. for 3 hours. The crude product was then separated from the aqueous layer. Then, 600 mL diethyl ether (ether) and 400 mL deionized water were added, and the solution was extracted twice with 400 mL sodium bicarbonate solution (0.5%) and then with distilled water until the washing had neutral pH. The product (655.8 grams) was then added slowly into a mixture of methanol/water (508.2 g/147.97 g). The bottom organic layer was separated, added with diethyl ether and dried with magnesium sulfate. Ether was then stripped under vacuum at room temperature and the residue was further stripped under vacuum (0.07-mm torr) at 80° C. The final product was recovered. The molecular weight (Mn) as determined by H-NMR was 4800.

### EXAMPLE 2

### Preparation of a Polydimethylsiloxane-Based Prepolymer Using PDMS of Example 1

A dry 3-neck, 500-mL round-bottom flask was connected to a nitrogen inlet tube and a reflux condenser. The following were added to the flask all at once: isophorone diisocyanate (7.825 g, 35.202 mmol) (IPDI); α,ω-bis(4-hydroxybutyl)polydimethyl-siloxane (94.31 g, 19.648 mmol) from Example 1; dibutyl tin dilaurate (0.297 g); and 250 mL methylene chloride. The contents were refluxed, and after overnight, the amount of isocyanate was determined to decrease to 44.5% by titration. Then diethyleneglycol (1.421 g, 13.391 mmol) (DEG) was added to the flask. The refluxing was continued overnight, and the amount of isocyanate decreased to 5.1% of the original as determined by titration. Then the contents were cooled down to ambient temperature. 1,1′-bi-2-phenol (0.013 g) and 2-hydroxyethyl methacrylate (0.819 g, 6.293 mmol) were then added and the contents were stirred at ambient until isocyanate peak at 2267 cm⁻¹ disappeared from IR spectrum of the product (about 20 hours). The solvent was then stripped under reduced pressure and 82 grams of product were recovered.

### EXAMPLE 3

Casting of Silicone Hydrogels from Monomer Mixture Comprising Polysiloxane-Based Prepolymer and Hydrophilic Monomer

A monomer mixture was prepared by mixing the following components (where “pbw” denotes “parts by weight” and “ppm” denotes “parts per million”): the polydimethylsiloxane-based prepolymer of Example 2 (65 pbw); methacryloxypropyl tris(trimethylsiloxy)silane (TRIS, 10 pbw);); N,N-dimethylacrylamide (DMA, 25 pbw); n-hexanol (10 pbw); Darocur-1173™ UV photo initiator (0.5 pbw) (available from Ciba Specialty Chemical, Ardsley N.Y.); and 1,4-bis(2-methacrylamidoethylamino) anthraquinone as a tint (150 ppm). The monomer mixture appeared clear, was cast between pairs of silane-treated glass plates, and then exposed to UV light for one hour to cure the monomer mixtures in the form of clear films. The pairs of glass plates were separated by Teflon™ polymer tapes of different thicknesses to obtain a series of films with thicknesses of about 200, 400 and 600 microns. The cured films were released from the plates and extracted with isopropanol overnight, followed by hydration in deionized (DI) water, boiled in DI water for one hour and then saturated in borate buffered saline or phosphate buffered saline to yield hydrated hydrogel films which were optically clear.

### EXAMPLE 4a

### Casting of Silicone Hydrogels from Monomer Mixture Comprising Polysiloxane-Based Prepolymer and Hydrophilic Monomers

A monomer mixture was prepared as in Example 3. This monomer mixture included the same components as in Example 3, with the amounts listed in Table 1, and further including 5 pbw of 2-hydroxyethylmethacrylate (HEMA). This monomer mixture was noticeably hazy. Films were cast from this mixture following the general procedure of Example 3, and the resultant hydrated films were very hazy and unacceptable as a contact lens material.

### EXAMPLE 4b

### Casting of Silicone Hydrogels from Monomer Mixture Comprising Polysiloxane-Based Prepolymer and Hydrophilic Monomers

A monomer mixture was prepared employing the same components in the same amounts as Example 4a. The monomer mixture was heated with an air gun for a few minutes until it became optically clear. Immediately after heating the monomer mixture, the mixture was cast into films following the general procedure of Example 3. The resultant films were optically clear. Properties of the hydrated films were measured as in Example 3 and are listed in Table 1.

TABLE 1

| | Example 3 | Example 4a | Example 4b |
|---|---|---|---|
| Prepolymer (pbw) | 65 | 65 | 65 |
| TRIS (pbw) | 10 | 10 | 10 |
| DMA (pbw) | 25 | 25 | 25 |
| HEMA (pbw) | 0 | 5 | 5 |
| n-hexanol (pbw) | 10 | 15 | 15 |
| Initiator (pbw) | 0.5 | 0.5 | 0.5 |
| Tint (ppm) | 150 | 150 | 150 |
| Water Content (wt %) | 31.7 | — | 39.9 |
| Dk (barrer) | 158 | — | 174 |
| Modulus (g/mm²) | 60 | — | 37 |
| Percent elongation (%) | 322 | — | 361 |
| Tensile strength (g/mm²) | 60 | — | 40 |
| Tear strength (g/mm) | 10 | — | 13 |

Example 3 illustrates the preparation of silicone hydrogels by conventional UV curing. This monomer mixture yielded clear hydrogels without the necessity of heating the monomer mixture. Comparing Example 3 and Example 4a, the compositions of these monomer mixtures did not differ much, however, casting of films from the Example 4a monomer mixture by conventional UV curing resulted in unacceptably cloudy hydrogels. Example 4b illustrates that the method of this invention yielded optically clear hydrogels from a monomer mixture similar to that in Example 4a. Example 4b also illustrates that optically clear silicone hydrogels with desirably higher oxygen permeability and lower modulus can be obtained by the method of this invention.

The properties listed in Table 1 were determined by the following procedures.

Water content of the hydrated films was measured gravimetrically. Modulus, percent elongation and tensile strength tests were conducted according to ASTM D-1708a, employing an Instron (Model 4502) instrument where the hydrogel film sample is immersed in borate buffered saline; an appropriate size of the film sample is gauge length 22 mm and width 4.75 mm, where the sample further has ends forming a dogbone shape to accommodate gripping of the sample with clamps of the Instron instrument, and a thickness of 200+50 microns. Tear strength tests were conducted according to ASTM D-1938 using the Instron Model 4502 instrument.

Oxygen permeability (also referred to as Dk) was determined by the following procedure. Other methods and/or instruments may be used as long as the oxygen permeability values obtained therefrom are equivalent to the described method. The oxygen permeability of silicone hydrogels is measured by the polarographic method (ANSI Z80.20-1998) using an O2 Permeometer Model 201T instrument (Createch, Albany, Calif. USA) having a probe containing a central, circular gold cathode at its end and a silver anode insulated from the cathode. Measurements are taken only on pre-inspected pinhole-free, flat silicone hydrogel film samples of at least three different center thicknesses ranging from 150 to 600 microns. Center thickness measurements of the film samples may be measured using a Rehder ET-1 electronic thickness gauge. Generally, the film samples have the shape of a circular disk. Measurements are taken with the film sample and probe immersed in a bath containing circulating phosphate buffered saline (PBS) equilibrated at 35° C.+/−0.2°. Prior to immersing the probe and film sample in the PBS bath, the film sample is placed and centered on the cathode premoistened with the equilibrated PBS, ensuring no air bubbles or excess PBS exists between the cathode and the film sample, and the film sample is then secured to the probe with a mounting cap, with the cathode portion of the probe contacting only the film sample. For silicone hydrogel films, it is frequently useful to employ a Teflon polymer membrane, e.g., having a circular disk shape, between the probe cathode and the film sample. In such cases, the Teflon membrane is first placed on the pre-moistened cathode, and then the film sample is placed on the Teflon membrane, ensuring no air bubbles or excess PBS exists beneath the Teflon membrane or film sample. Once measurements are collected, only data with correlation coefficient value (R²) of 0.97 or higher should be entered into the calculation of Dk value. At least one Dk measurement per thickness, and meeting R² value, are obtained; preferably at least two Dk measurements per thickness. Using known regression analyses, oxygen permeability (Dk) is calculated from the film samples having at least three different thicknesses. Any film samples hydrated with solutions other than PBS are first soaked in purified water and allowed to equilibrate for at least 24 hours, and then soaked in PHB and allowed to equilibrate for at least 12 hours. The instruments are regularly cleaned and regularly calibrated using RGP standards. Upper and lower limits are established by calculating a +/−8.8% of the Repository values established by William J. Benjamin, et al., The Oxygen Permeability of Reference Materials, Optom Vis Sci 7 (12s): 95 (1997), the disclosure of which is incorporated herein in its entirety:

| | Repository | Lower | Upper |
|---|---|---|---|
| Material Name | Values | Limit | Limit |
| Fluoroperm 30 | 26.2 | 24 | 29 |
| Menicon EX | 62.4 | 56 | 66 |
| Quantum II | 92.9 | 85 | 101 |

### EXAMPLE 5

### Preparation of α,ω-bis(4-hydroxybutyl)polydimethylsiloxane (Mn about 6000)

The following were charged to a 2-L, three-neck round-bottom flask equipped with one reflux condenser: 27.52 grams (98.8 mmol) of 1,3-bishydroxybutyl tetramethyldisiloxane; 781.36 grams (6310 mmol) of dimethoxydimethylsilane; 113.27 grams (6293 mmol) of distilled water; and about 10 mL of concentrated hydrochloric acid. Following the general procedure of Example 1, the α,ω-bis(4-hydroxybutyl)polydimethylsiloxane was obtained, having a molecular weight (Mn) as determined by H-NMR of 6090.

### EXAMPLE 6

### Preparation of a Polydimethylsiloxane-Based Prepolymer Using PDMS of Example 1

A dry 3-neck, 500-mL round-bottom flask was connected to a nitrogen inlet tube and a reflux condenser. The following were added to the flask: DEG (0.498 g, 4.696 mmol); methylene chloride (150 ml); IPDI (2.111 g, 9.498 mmol); and dibutyltin dilaurate (0.161 g). The contents were refluxed, and after overnight, the amount of isocyanate was determined by titration to decrease to 43.3% of original. Then, PDMS diol (45.873 g, 8.554 mmol) of Example 1 was added to the flask. Refluxing was continued overnight, and the amount of isocyanate decreased to 22.9% of the original as determined by titration. IPDI (1.261 g, 5.674 mmol) was added, with refluxing overnight, and the reaction mixture was allowed to cool down to room temperature. 1,1′-bi-2-naphthol (0.008 g) and HEMA (0.429 g, 3.296 mmol) were added and the reaction was carried on for two days until IR spectrum of the product showed absence of isocyanate peak at 2267 cm⁻¹. The solvent was stripped under reduced pressure and the product was recovered (44.55 g).

### EXAMPLE 7

### Preparation of a Polydimethylsiloxane-Based Prepolymer Using PDMS of Example 1

The general procedure of Example 2 is followed, instead employing the following: PDMS (72.71 g, 15.148 mmol) of Example 1; methylene chloride (200 ml); dibutyltin dilaurate (0.215 g); IPDI (6.650 g, 29.918 mmol); DEG (1.186 g, 11.172 mmol); 1,1′-bi-2-naphthol (0.012 g); and HEMA (0.986 g, 7.576 mmol).

### EXAMPLE 8

### Preparation of a Polydimethylsiloxane-Based Prepolymer Using PDMS of Example 1

The general procedure of Example 2 is followed, instead employing a 1000-ml round bottom three-neck flask and the following: PDMS (133.47 g, 27.806 mmol) of Example 1; methylene chloride (300 ml); dibutyltin dilaurate (0.404 g); IPDI (12.370 g, 55.649 mmol); DEG (2.257 g, 21.270 mmol); 1,1′-bi-2-naphthol (0.021 g); and HEMA (1.678 g, 2.890 mmol).

### EXAMPLE 9

### Preparation of a Polydimethylsiloxane-Based Prepolymer Using PDMS of Example 5

The general procedure of Example 2 is followed, instead employing the following: PDMS (73.93 g, 12.140 mmol) of Example 5; methylene chloride (200 ml); dibutyltin dilaurate (0.235 g); IPDI (5.386 g, 24.231 mmol); DEG (0.903 g, 8.505 mmol); 1,1′-bi-2-naphthol (0.012 g); and HEMA (0.847 g, 6.508 mmol).

### EXAMPLES 10-13

### Casting of Silicone Hydrogels from Monomer Mixture Comprising Polysiloxane-Based Prepolymer and Hydrophilic Monomer

Monomer mixtures were prepared by mixing the components listed in Table 1, where “NVP” denotes N-vinyl pyrrolidone and “HemaVC” denotes methacryloxyethyl vinylcarbonate”. Each of the monomer mixtures was noticeably hazy or cloudy.

The monomer mixtures of Example 10, 11 and 13 were heated with an air gun for a few minutes until they became optically clear. The monomer mixture of Example 12 was heated until it became clear by immersing a test tube with the monomer mixture in a heated water bath until the mixture reached 70° C.

Immediately after heating the monomer mixtures, the mixtures were cast into films following the general procedure of Example 3 and 4. In the case of Example 12, the silane-treated glass plates were preheated in an oven to 70° C. before curing of the monomer mixture between the plates. The resultant films were optically clear. Properties of the hydrated films were measured as in Examples 3 and 4, and are listed in Table 2.

TABLE 2

| | Example | Example | Example | Example |
|---|---|---|---|---|
| | 10 | 11 | 12 | 13 |
| Prepolymer Ex 6 (pbw) | 60 | — | — | — |
| Prepolymer Ex 7 (pbw) | — | 40 | — | — |
| Prepolymer Ex 8 (pbw) | — | — | 40 | — |
| Prepolymer Ex 9 (pbw) | — | — | — | 60 |
| TRIS (pbw) | 15 | 20 | 20 | 15 |
| DMA (pbw) | — | 10 | 10 | — |
| HEMA (pbw) | 5 | 3 | 3 | 5 |
| NVP (pbw) | 22 | 30 | 35 | 25 |
| HemaVC | 0.5 | 0.7 | 0.7 | 0.5 |
| n-hexanol (pbw) | 10 | 10 | 10 | 10 |
| Initiator (pbw) | 0.5 | 0.5 | 0.5 | |
| Tint (ppm) | 150 | 150 | 150 | |
| Water Content (wt %) | 36.5 | 47.4 | 47.8 | 26.8 |
| Dk (barrer) | 172 | 97 | 90 | 191 |
| Modulus (g/mm²) | 49 | 55 | 64 | 106 |
| Percent elongation (%) | 106 | 134 | 151 | 133 |
| Tensile strength | 26 | 38 | 47 | 62 |
| (g/mm²) | | | | |
| Tear strength (g/mm) | 5 | 3 | 3 | 4 |

### EXAMPLES 14 TO 15

The general procedure of Example 1 is followed to obtain PDMS having Mn of about 4700. The general procedure of Example 2 is followed, using this PDMS, and employing the following: PDMS (116.46 g, 24.651 mmol); methylene chloride (300 ml); dibutyltin dilaurate (0.302 g); IPDI (10.957 g, 49.292 mmol); DEG (2.411 g, 22.719 mmol); 1,1′-bi-2-naphthol (0.018 g); and HEMA (1.393 g, 10.704 mmol).

Monomer mixtures were prepared by mixing the components listed in Table 3, using the prepolymer of this example, where GMA denotes glyceryl methacylate. Each of the monomer mixtures was noticeably hazy or cloudy. Each of the monomer mixtures was heated by placing in an oven preheated to 43° C. for 10 minutes, at which point the mixtures were then clear. Immediately after heating the monomer mixtures, the mixtures were cast into films following the general procedure of Example 3 and 4. The resultant films were optically clear.

TABLE 3

| | Example14 | Example 15 |
|---|---|---|
| Prepolymer (pbw) | 65 | 65 |
| TRIS (pbw) | 10 | 10 |
| DMA (pbw) | 8 | 8 |
| HEMA (pbw) | 5 | — |
| NVP (pbw) | 14 | 14 |
| GMA (pbw) | — | 5 |
| HemaVC | 0.5 | 0.5 |
| n-hexanol (pbw) | 10 | 10 |
| Initiator (pbw) | 0.5 | 0.5 |
| Tint (ppm) | 150 | 150 |
| Water Content (wt %) | 28 | 31 |
| Modulus (g/mm²) | 88 | 86 |
| Percent elongation (%) | 78 | 146 |
| Tensile strength (g/mm²) | 32 | 44 |
| Tear strength (g/mm) | 5 | 5 |
| Dk (barrer) | 205 | 212 |

Having thus described various preferred embodiment of the invention, those skilled in the art will appreciate that various modifications, additions, and changes may be made thereto without departing from the spirit and scope of the invention, as set forth in the following claims.

We claim:

1. A method of making a silicone hydrogel biomedical device, comprising:
forming a monomer mixture comprising a silicone-containing monomer and a hydrophilic monomer;
heating the monomer mixture to reduce cloudiness of the mixture; and
curing the monomer mixture.

2. The method of claim 1, wherein the monomer mixture is heated until it is optically clear.

3. The method of claim 1, wherein curing the monomer mixture includes exposing the monomer mixture to light energy.

4. The method of claim 3, wherein the monomer mixture is exposed to ultraviolet light.

5. The method of claim 3, wherein the monomer mixture is exposed to light energy while retained in a mold.

6. The method of claim 5, wherein a molding surface of the mold is lens-shaped.

7. The method of claim 5, further comprising removing a cured article from the mold, and hydrating the article.

8. The method of claim 5, wherein the monomer mixture is heated prior to charging the monomer mixture to the mold.

9. The method of claim 5, wherein the monomer mixture is heated while contained in the mold.

10. The method of claim 1, wherein the silicone-containing monomer includes a polysiloxane-containing prepolymer.

11. The method of claim 10, wherein the polysiloxane prepolymer has a silicon atom content of at least 25 weight % of the prepolymer.

12. The method of claim 1, wherein the monomer mixture comprises at least one hydrophilic monomer selected form the group consisting of: unsaturated carboxylic acids; (meth)acrylic substituted alcohols; vinyl lactams; and (meth)acrylamides.

13. The method of claim 12, wherein the monomer mixture comprises at least one hydrophilic monomer selected form the group consisting of: methacrylic acid; acrylic acid; 2-hydroxyethylmethacrylate; glyceryl methacrylate; N-vinyl pyrrolidone; methacrylamide; and N,N-dimethylacrylamide.

14. The method of claim 13, wherein the monomeric mixture comprises at least one (meth)acrylic substituted alcohol.

15. The method of claim 1, wherein the device is an ophthalmic lens.

16. The method of claim 15, wherein the device is a contact lens.
